(19) United States
(12) Patent Application Publication
(10) Pub. No.: US 2014/0201193 A1
(43) Pub. Date: Jul. 17, 2014

(54) INTELLECTUAL PROPERTY ASSET INFORMATION RETRIEVAL SYSTEM

(71) Applicant: WISDOMAIN INC., Gyeonggi-do (KR)

(72) Inventors: Ilsoo Kim, Gyeonggi-do (KR); Seungho Jung, Gyeonggi-do (KR)

(73) Assignee: WISDOMAIN INC., Gyeonggi-do (KR)

(21) Appl. No.: 13/742,485

(22) Filed: Jan. 16, 2013

(51) Int. Cl. G06F 17/30

(52) U.S. Cl. CPC G06F 17/30424
USPC 707/722

(57) ABSTRACT

An approach for automatically retrieving information corresponding to intellectual property (IP) assets in a networked computing environment is provided. In general, a user will submit search input (e.g., keywords, patent numbers, etc.), that is used to search an intellectual property databases (e.g., USPTO) to generate a set of matching results. IP identifier information will then be extracted from the set of results and matched against a set of tables containing deterministic (e.g., legal/litigation) information corresponding to a set of IP assets (e.g., patents, trademarks, copyrights, etc.). Any deterministic information corresponding to IP assets that match the IP identifier information extracted from the set of results may then be outputted for the user. Thus, the user may see any deterministic information that corresponds to an IP asset in which the user may be interested.

### TECHNICAL FIELD

Aspects of the present invention relate to information retrieval. Specifically, the present invention relates to the retrieval and collation of intellectual property asset information (e.g., in tables or the like) using deterministic (e.g., legal) information/data in a networked computing environment.

### BACKGROUND

As business competition has become more global, the capability to view technological trends of a specific industry (or to analyze technological competitiveness) has become highly critical. One manner of determining industry trends and/or competiveness is to view various online references such as patent documents. Specifically, intellectual property (IP) documents (e.g., issued patents and/or published patent applications) are good indicators of industry trends and the directions in which competitors are shaping their product lines.

Unfortunately, analyzing sets of patent documents and collating related information such as legal information into cohesive reports remains a time-consuming and manual process. Intellectual property infringement litigation is a big threat to a defendant company. As such, a company should be aware of the intellectual properties in its industry to avoid possible infringement issues. Typically, a user will perform various manual searches of pending legal actions and then attempt to manually collate and organize the large volume of information into meaningful data. Such a requirement is both time consuming and costly. These issues are compounded when the user wishes to include IP-specific information such as patent document information, which requires an additional search of a different set of records.

### SUMMARY

In general, embodiments of the present invention provide an approach for automatically retrieving information corresponding to intellectual property (IP) assets in a networked computing environment. In a typical embodiment, a user will submit search input (e.g., keywords, patent numbers, etc.), that is used to search an intellectual property database (e.g., USPTO) to generate a set of matching results. IP identifier information will then be extracted from the set of results and matched against a set of tables containing deterministic (e.g., legal/litigation) information corresponding to a set of IP assets (e.g., patents, trademarks, copyrights, etc.). Any deterministic information corresponding to IP assets that match the IP identifier information extracted from the set of results may then be outputted for the user. Thus, the user may see any deterministic information that corresponds to an IP asset in which the user may be interested.

A first aspect of the present invention provides a computer-implemented method for retrieving information in a networked computing environment, comprising: receiving search input in a computer memory medium; querying an intellectual property database using the search input to generate a set of results; extracting intellectual property identifier information from the set of results; matching the extracted intellectual property identifier information against a set of data contained in a set of tables, the set of data comprising deterministic information corresponding to a set of intellectual property assets; and outputting, based on the matching, the deterministic information for the intellectual property assets that correspond to the intellectual property identifier information extracted from the set of results.

A second aspect of the present invention provides a system for retrieving information in a networked computing environment, comprising: a memory medium comprising instructions; a bus coupled to the memory medium; and a processor coupled to the bus that when executing the instructions causes the system to: receive search input in a computer memory medium; query an intellectual property database using the search input to generate a set of results; extract intellectual property identifier information from the set of results; match the extracted intellectual property identifier information against a set of data contained in a set of tables, the set of data comprising deterministic information corresponding to a set of intellectual property assets; and output, based on the match, the deterministic information for the intellectual property assets that correspond to the intellectual property identifier information extracted from the set of results.

A third aspect of the present invention provides a computer program product for retrieving legal information in a networked computing environment, the computer program product comprising a computer readable storage media, and program instructions stored on the computer readable storage media, to: receive search input in a computer memory medium; query an intellectual property database using the search input to generate a set of results; extract intellectual property identifier information from the set of results; match the extracted intellectual property identifier information against a set of data contained in a set of tables, the set of data comprising deterministic information corresponding to a set of intellectual property assets; and output, based on the match, the deterministic information for the intellectual property assets that correspond to the intellectual property identifier information extracted from the set of results.

A fourth aspect of the present invention provides a method for deploying a system for retrieving legal information in a networked computing environment, comprising: providing a computer infrastructure being operable to: receive search input in a computer memory medium; query an intellectual property database using the search input to generate a set of results; extract intellectual property identifier information from the set of results; match the extracted intellectual property identifier information against a set of data contained in a set of tables, the set of data comprising deterministic information corresponding to a set of intellectual property assets; and output, based on the match, the deterministic information for the intellectual property assets that correspond to the intellectual property identifier information extracted from the set of results.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a more detailed system diagram according to an embodiment of the present invention.

FIG. 3 depicts a system flow diagram according to an embodiment of the present invention

FIG. 4 depicts a table according to an embodiment of the present invention.

FIG. 5A-B depict additional tables according to an embodiment of the present invention.

FIG. 6 depicts a method flow diagram according to an embodiment of the present invention.

FIG. 7 depicts a method flow diagram according to an embodiment of the present invention.

FIG. 8 depicts a method flow diagram according to an embodiment of the present invention.

FIG. 9 depicts an illustrative interface according to an embodiment of the present invention.

FIG. 10 depicts another illustrative interface according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The word “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

In general, embodiments of the present invention provide an approach for automatically retrieving information corresponding to intellectual property (IP) assets in a networked computing environment. In a typical embodiment, a user will submit search input (e.g., keywords, patent numbers, etc.), that is used to search an intellectual property database (e.g., USPTO) to generate a set of matching results. IP identifier information will then be extracted from the set of results and matched against a set of tables containing deterministic (e.g., legal/litigation) information corresponding to a set of IP assets (e.g., patents, trademarks, copyrights, etc.). Any deterministic information corresponding to IP assets that match the IP identifier information extracted from the set of results may then be outputted for the user. Thus, the user may see any deterministic information that corresponds to an IP asset in which the user may be interested.

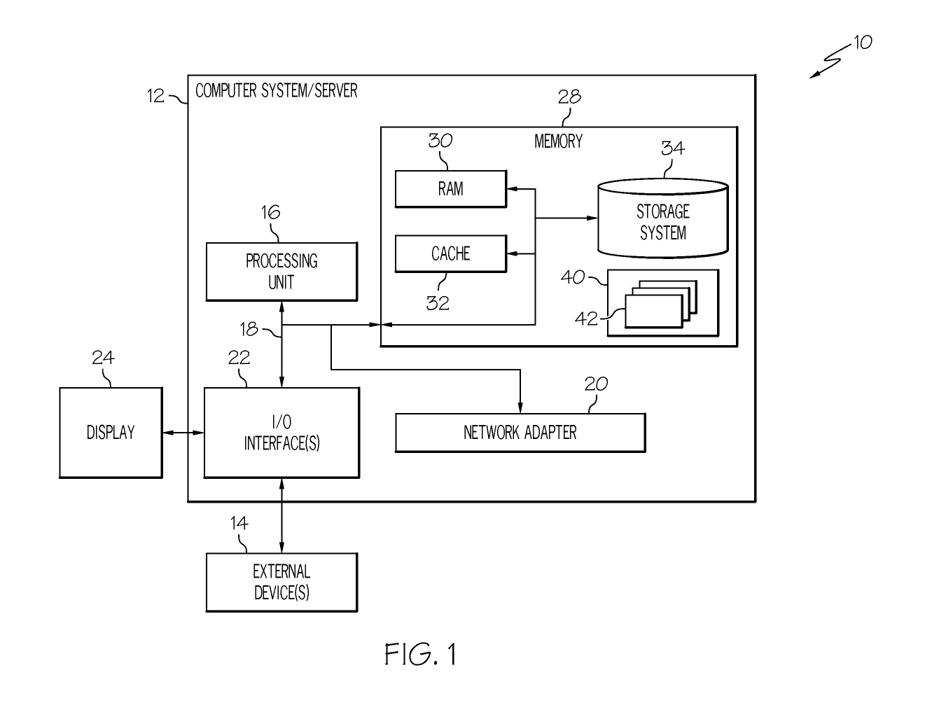

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin potential clients, thick potential clients, hand-held or laptop devices, mobile devices, global positioning systems (GPS), GPS-enabled devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each such media component can be connected to bus 18 by one or more data media interfaces. As will be further depicted and described below, memory 28 may include at least one program product having a set (e.g., at least one) of program modules that are configured to carry out the functions of embodiments of the invention.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation. Memory 28 may also have an operating system, one or more application programs, other program modules, and program data. In general, program/utility 40 performs the function of the present invention as described herein. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is understood in advance that although a typical embodiment described herein pertains to the analysis of patent documents, this need not be the case. Rather, similar teachings could be applied to the generation of analysis reports for any type of electronic documents. Moreover, although an illustrative embodiment referred to herein describe legal information and legal databases, this need not be the case. Rather the teachings described herein could be applied to any type of deterministic information (e.g., legal, administrative, etc.).

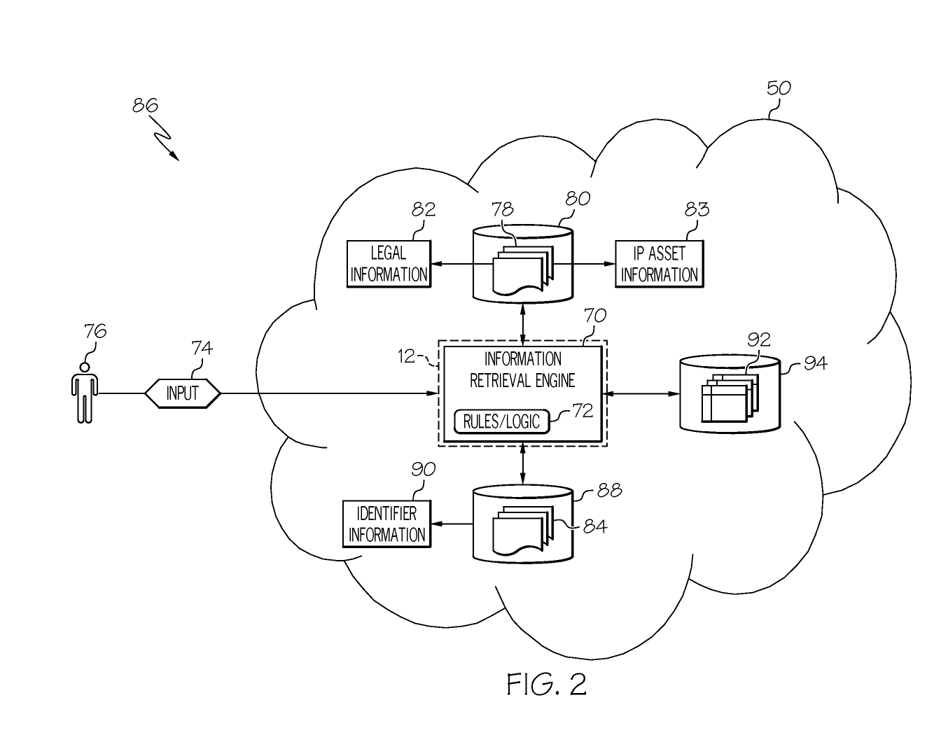

Referring now to FIG. 2, a system diagram describing the functionality discussed herein according to an embodiment of the present invention is shown. It is understood that the teachings recited herein may be practiced within any type of networked computing environment 86 (e.g., a cloud computing environment 50). A computer system/server 12, which can be implemented as either a stand-alone computer system or as a networked computer system is shown. In the event the teachings recited herein are practiced in a networked computing environment 86, each client need not have an information retrieval engine (engine 70). Rather, engine 70 could be loaded on a server or server-capable device that communicates (e.g., wirelessly) with the clients to provide information retrieval functionality. Regardless, as depicted, engine 70 is shown within computer system/server 12. In general, engine 70 can be implemented as program/utility 40 on computer system 12 of FIG. 1 and can enable the functions recited herein. As further shown, engine 70 (in one embodiment) comprises a rules and/or computational engine that processes a set (at least one) of rules/logic 72 and/or provides information retrieval hereunder.

Along these lines, engine 70 may perform multiple functions similar to a general-purpose computer. Specifically, among other functions, engine 70 may (among other things):
retrieve a set of legal documents 78 from at least one legal database 80, the set of legal documents 78 having deterministic/legal information 82 pertaining to a set of legal actions (e.g., a set of case numbers associated with a set of legal actions, identities of parties to the set of legal actions, dates in which the set of legal actions were filed, courts in which the set of legal actions are pending, statuses of the set of legal actions, etc.);
parse the set of legal documents 78 to identify legal documents having intellectual property (IP) asset information 83 (e.g., a patent application serial number, a patent number, a patent publication number, a title, an applicant, an assignee, a patent application filing date, a patent classification, a patent issuance date, a trademark application serial number, a trademark registration number, a trademark classification, etc.);
generate a set of tables 92 (stored in a resource database 94) based on the set of legal documents 78, the set of tables 92 associating the legal information 82 with the IP asset information 83;
receive search input 74 (a set of keywords, a set of patent numbers, etc.) in a computer memory medium 28 (FIG. 1) from a user 76 or the like;
query an IP database 88 (e.g., having IP documents 84) using the search input to generate a set of results;
extract IP identifier information 90 (e.g., patent numbers) from the set of results;
match the extracted IP identifier information 90 against a set of data contained in the set of tables 92, the set of data comprising the deterministic/legal information 82 corresponding to a set of IP assets (represented by documents 84); and/or
output, based on the match, the deterministic/legal information 82 for the IP assets 84 that correspond to the IP identifier information 90 extracted from the set of results.

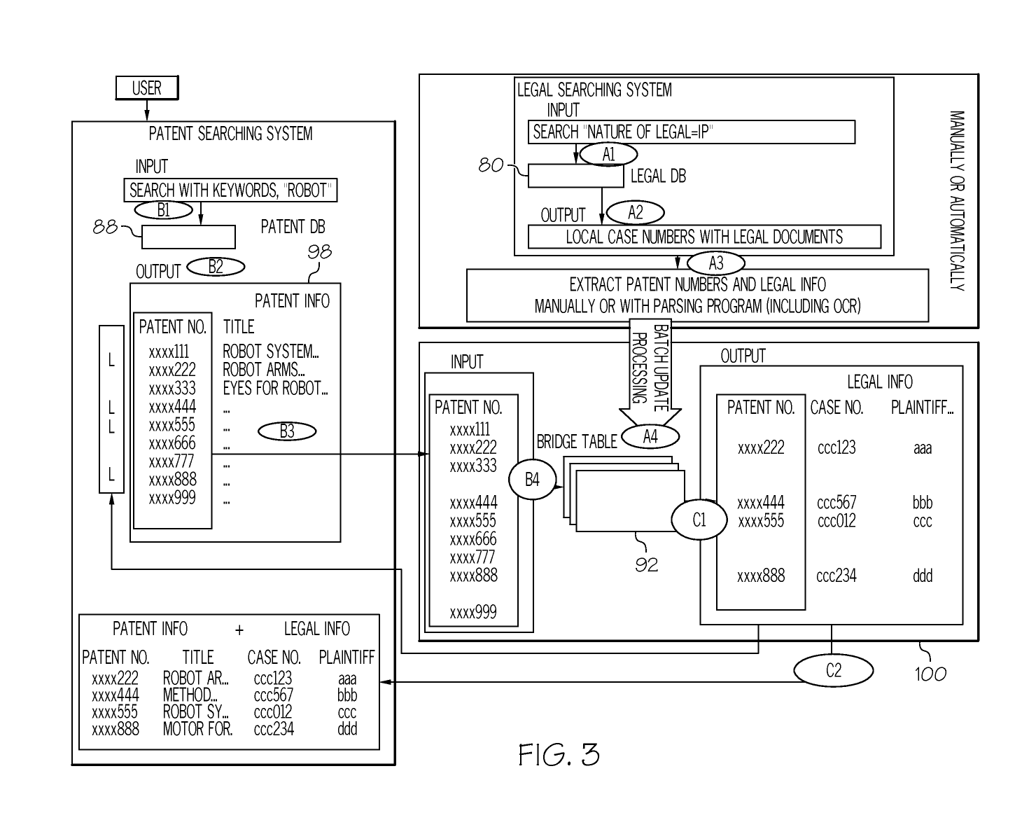

These concepts are more specifically depicted in the system flow diagram of FIG. 3. It is reiterated that although the illustrative example shown in FIG. 3 discusses legal or litigation information, the teachings recited herein could be implemented in conjunction with any type of deterministic information. Specifically, FIG. 3 shows three merged processes provided hereunder denoted by steps A1-A4, B1-B4, and C1-C2 (e.g., enabled by program 40 and/or engine 70 or subsystems thereof). Referring first to steps A1-A4, the building of an initial table of deterministic/legal information will be described. Specifically, steps A1-A4 show the building of a table having legal information corresponding to legal actions involving IP assets. In step A1, a search will be conducted of a legal (e.g., litigation) database 80 using key words or the like. The search will include a search of legal documents or the like. In step A2, results are returned that may include legal information such as litigation case numbers associated with the legal documents. In step A3, patent numbers or other IP asset information is extracted along with the legal information from the legal documents (e.g., using optical character recognition (OCR) or the like, and in step A4 this combined information is populated into a set of table(s) 92 (e.g., stored in a “resource” database 94 or the like such as that shown in FIG. 2). This process can be repeated over time (e.g., in a batch process mode) so that table(s) 92 stay current.

Steps B1-B4 show a user-based query of a patent database 88. As depicted, in step B1, a user inputs keywords or the like. In step B2, a search is conducted of a patent database 88 and a set/list of results 98 can be returned in step B2. As shown, the list of results 98 may include a list of IP asset information such as patent numbers, titles, etc. as well as one or more tags such as an “L” to indicate a case under litigation. In step B3, the results 88 or a subset thereof (e.g., the results with an “L” tag) will be matched against the information/data previously stored in the table via steps A1-A4, and populated into corresponding locations in table(s) 92 in step B4.

The process is completed in steps C1-C2 with the generation of output for the user. Specifically, in step C1, a report 100 or the like is generated based on table(s) 92. This can include the ability of the user to configure or request particular pieces of information/data, request certain report formats, etc. In any event, report 100 will be delivered in step C2. In one embodiment, report 100 can include, highlight, or prioritize IP assets (patents) undergoing litigation along with other pertinent information about the particular case and/or asset itself. It is understood that the user may also query the resource database itself to access results/tables previously generated.

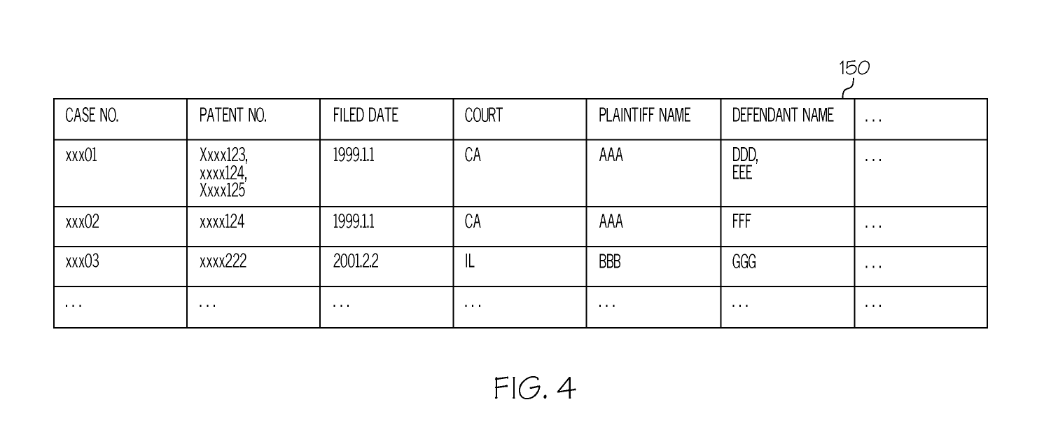

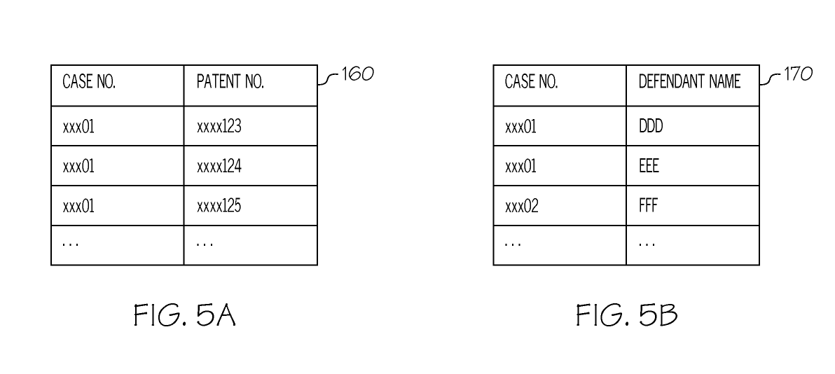

In providing this functionality, engine/system 70 will generate and populate the set of tables 92 (as mentioned above). FIGS. 4 and 5A-B shows various tables 150, 160, and 170 that may be provided hereunder. It is understood in advance that tables 150, 160, and 170 are intended to be illustrative only. It is further understood that tables 150, 160, and 170 may be “live” or interactive tables in which the data contained therein is hyperlinked to other electronic documents and/or sources (or even other tables). Further, although tables 150, 160, and 170 will depict “patent” information, they include information pertaining to any type of intellectual property (e.g., trademarks, copyrights, etc.) As first shown in FIG. 4, table 150 may contain all case related information (e.g., with a case number), and permits multiple values in a field in a record (a cell) with a proper separator. As shown, table 150 includes case docket numbers, patent numbers, case filing dates, courts in which the cases are pending, plaintiff names, defendant names, etc. Table 150 could be populated as described above by using search terms to query legal databases, retrieving relevant legal documents, and extracting the information therefrom. As such, rules 72 will indicate how to identify such information in legal documents.

In any event, FIGS. 5A-B show tables 160 and 170 typically represent sub-tables that could result from table 150. As first shown, table 160 includes case numbers and patent numbers (e.g., of those patents involved in the litigation), while table 170 includes case numbers and defendant names. This demonstrates that rules 72 may be configured to allow a user to request generation of any subset of information in a table or other report format.

It is understood that the information contained in tables 150, 160, and 170 may be used to mine additional information such as document information from the IP documents themselves. For example, a particular patent number may be clicked on/selected to access a corresponding patent document in a patent database (e.g., USPTO). Engine 70 may then parse that patent document and extract additional information such as inventors, assignees, serial numbers, publication numbers, related application data, foreign filing information, classes and sub-classes, patents cited against the selected patent, patents in which the selected patent was cited against, etc. This additional information may be populated into tables 150, 160, and/or 170, or populated into one or more additional tables. Moreover, the additional information may be used to further search the legal and/or patent databases for other relevant information. For example, if an original selected patent had a related patent that was also issued, that related patent's number could be use to identify counterpart legal actions involving the related patent.

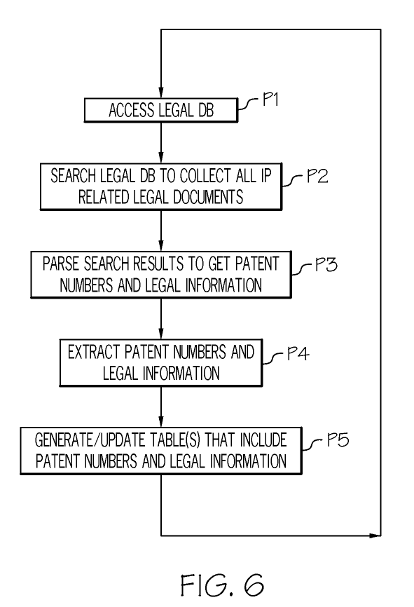

Referring to FIGS. 6-8, method flow diagrams illustrating some of the processes described above are shown. It is understood that FIGS. 6-8 are typically implemented by program 40 (FIG. 1) and/or engine 70 (FIG. 2). Referring first to FIG. 6, a flow diagram describing the querying of a legal database is shown (similar to steps A1-A4 of FIG. 3). In step P1, a legal database is accessed. In step P2, the legal database is searched to collect all IP related legal documents. In step P3, the search results are parsed to identify IP asset information and legal information. In step P4, the IP asset information and legal information is extracted and then populated into the set of tables in step P5 (which may be stored in a resource database or the like).

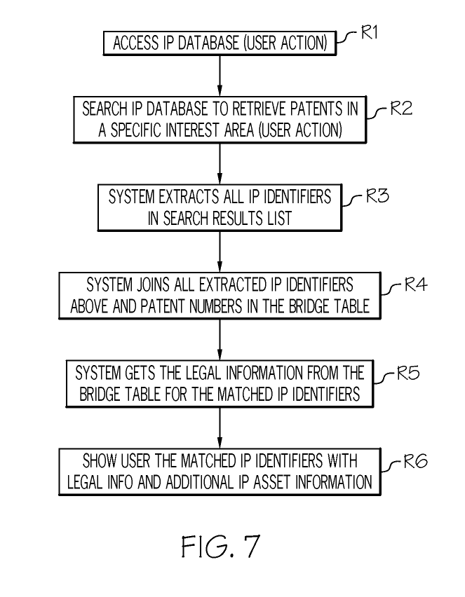

Referring next to FIG. 7, a flow diagram describing the querying of a patent database is shown (similar to steps B1-B4 of FIG. 3). In step R1, an IP (e.g., patent) database is accessed. In step R2, the IP database is searched in a specific area (e.g., based upon keywords, patent numbers, etc.). In step R3, all IP identifier information (identifiers) is extracted and placed into a search results list. In step R4, the system joins/merges the extracted IP identifiers from step R3 with those populated into the set of tables in step P5 of FIG. 6. In this step, the system may extract other IP asset information for any of the IP assets identified in the results. For example, the system could extract any information contained in an IP document. In step R5, the system retrieves the legal information for any matched IP identifiers (matching the user's query). In step R6, the IP asset information, legal information, and any other gathered information may be presented to the user.

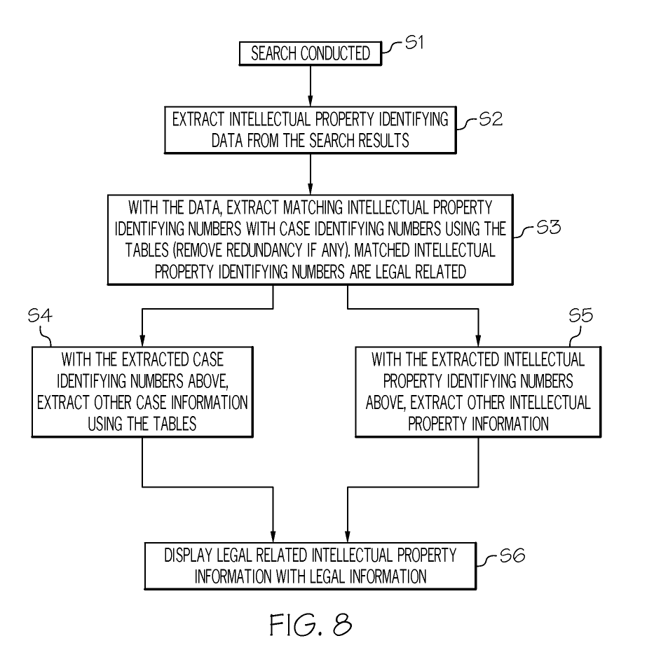

Referring now to FIG. 8, a method flow diagram according to a typical embodiment of the present invention is shown. In step S1, a search is conducted. In step S2, IP identifying data is extracted from the search results. In step S3, matching IP numbers are extracted from the results and used to mine additional legal information. In steps S4 and S5, the extracted information is used to determine other case information and other IP-related information. In step S6, all of this information can be displayed in one or more tables.

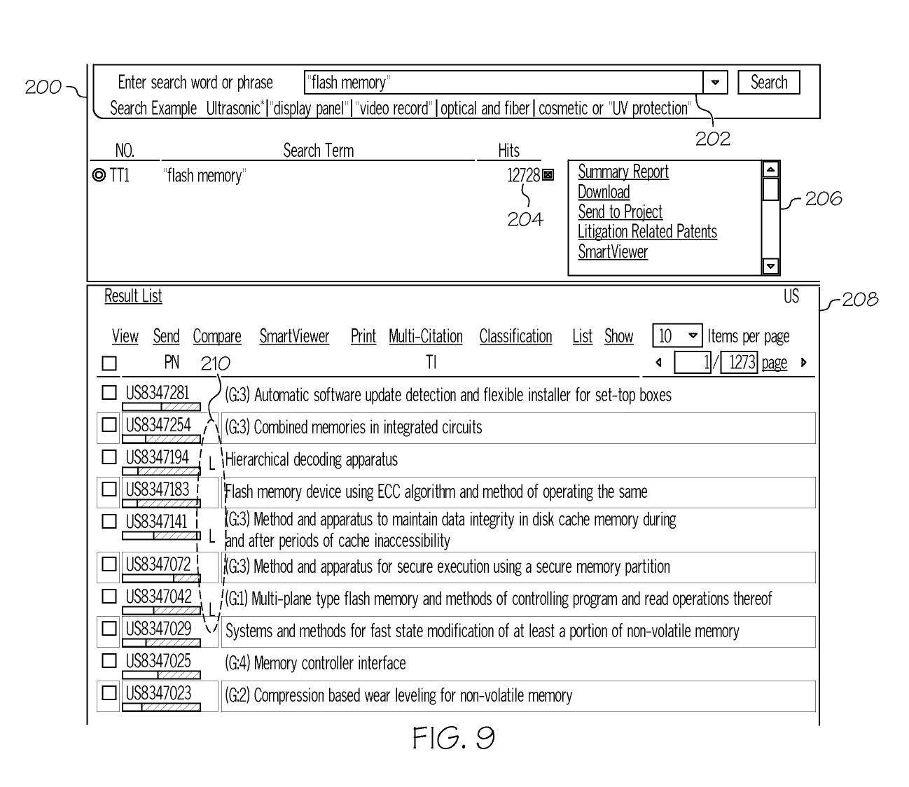

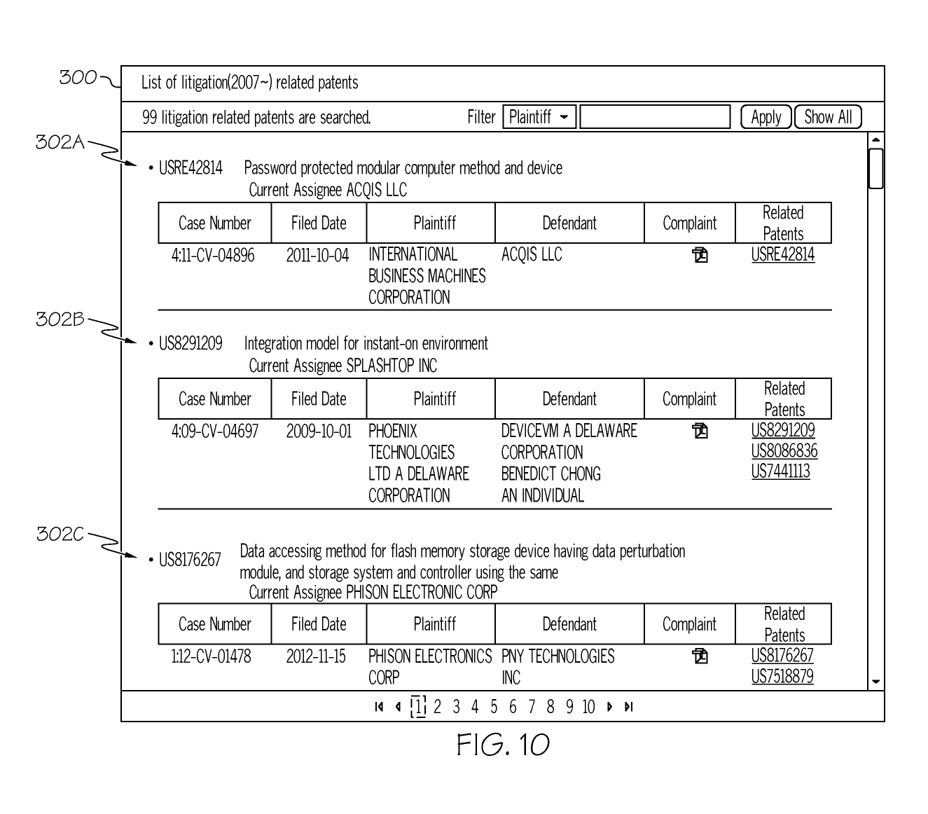

In performing these functions, engine 70 may also generate one or more interfaces that depict search results and provide hyperlinks to the various tables provided hereunder. Referring to FIG. 9, interface 200 is shown. As depicted, interface 200 has various fields of information. Examples shown include: search input 202, hit count 204 with option menu 206, and result list 208 that may include tags 210 to indicate whether certain results are legal related. Interface 200 may be interactive and contain live links to the underlying content. An additional interface/report 300 is shown in FIG. 10. Interface 300 results from selecting “Legal Related Patents” from menu 206 of interface 200. As shown in this example, “99” legal related patents resulted from the search using search input 202. They are detailed in interface 300, which may include multiple pages of results. In the example shown in FIG. 10, three patents 302A-C are displayed in a single screen as being involved in litigation. As further shown, corresponding information may be provided from cases associated with patents 302A-C. Such information may include case numbers, case filing dates, plaintiffs, defendants, links to case documents such as the complaint, related patents involved with the case, etc.

Thus, the aspects described herein provide a complete information retrieval system for IP matters. This allows, among other things, for IP asset information and legal information to be delivered via a single system into a comprehensive series or tables, reports, or the like.

While shown and described herein as an information retrieval system, it is understood that the invention further provides various alternative embodiments. For example, in one embodiment, the invention provides a computer-readable/useable medium that includes computer program code to enable a computer infrastructure to provide information retrieval as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide information retrieval functionality. In this case, the service provider can create, maintain, support, etc., a computer infrastructure, such as computer system/server 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method information retrieval. In this case, a computer infrastructure, such as computer system 12/server (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A computer-implemented method for retrieving information in a networked computing environment, comprising:
receiving search input in a computer memory medium;
querying an intellectual property database using the search input to generate a set of results;
extracting intellectual property identifier information from the set of results;
matching the extracted intellectual property identifier information against a set of data contained in a set of tables, the set of data comprising deterministic information corresponding to a set of intellectual property assets; and
outputting, based on the matching, the deterministic information for the intellectual property assets that correspond to the intellectual property identifier information extracted from the set of results.

2. The computer-implemented method of claim 1, the search input comprising at least one of the following: a set of keywords, or a set of patent numbers.

3. The computer-implemented method of claim 1, the intellectual property identifier information comprising a set of patent numbers, and the intellectual property assets comprising a set of patents.

4. The computer-implemented method of claim 1, the deterministic information comprising legal information obtained from at least one legal database, and the legal information corresponding to a set of legal actions involving the set of intellectual property assets.

5. The computer-implemented method of claim 4, the legal information comprising at least one of the following: a set of case numbers associated with the set of legal actions, identities of parties to the set of legal actions, dates in which the set of legal actions were filed, courts in which the set of legal actions are pending, or statuses of the set of legal actions.

6. The computer-implemented method of claim 1, further comprising generating the set of tables by performing the following:
retrieving a set of legal documents from at least one legal database, the set of legal documents having legal information pertaining to a set of legal actions;
parsing the set of legal documents to identify legal documents having intellectual property asset information; and
generating the set of tables based on the set of legal documents, the set of tables associating the legal information with the intellectual property asset information.

7. The computer-implemented method of claim 1, the intellectual property asset information comprising at least one of the following: a patent application serial number, a patent number, a patent publication number, a title, an applicant, an assignee, a patent application filing date, a patent classification, a patent issuance date, a trademark application serial number, a trademark registration number, or a trademark classification.

8. The computer-implemented method of claim 1, the set of tables being stored in a resource database.

9. A system for retrieving information in a networked computing environment, comprising:
a memory medium comprising instructions;
a bus coupled to the memory medium; and
a processor coupled to the bus that when executing the instructions causes the system to:
receive search input in a computer memory medium;
query an intellectual property database using the search input to generate a set of results;
extract intellectual property identifier information from the set of results;
match the extracted intellectual property identifier information against a set of data contained in a set of tables, the set of data comprising deterministic information corresponding to a set of intellectual property assets; and
output, based on the match, the deterministic information for the intellectual property assets that correspond to the intellectual property identifier information extracted from the set of results.

10. The system of claim 9, the search input comprising at least one of the following: a set of keywords, or a set of patent numbers.

11. The system of claim 9, the intellectual property identifier information comprising a set of patent numbers, and the intellectual property assets comprising a set of patents.

12. The system of claim 9, the deterministic information comprising legal information obtained from at least one legal database, and the legal information corresponding to a set of legal actions involving the set of intellectual property assets.

13. The system of claim 12, the legal information comprising at least one of the following: a set of case numbers associated with the set of legal actions, identities of parties to the set of legal actions, dates in which the set of legal actions were filed, courts in which the set of legal actions are pending, or statuses of the set of legal actions.

14. The system of claim 9, the memory medium further comprising instructions to:
retrieve a set of legal documents from at least one legal database, the set of legal documents having legal information pertaining to a set of legal actions;
parse the set of legal documents to identify legal documents having intellectual property asset information; and
generate the set of tables based on the set of legal documents, the set of tables associating the legal information with the intellectual property asset information.

15. The system of claim 9, the intellectual property asset information comprising at least one of the following: a patent application serial number, a patent number, a patent publication number, a title, an applicant, an assignee, a patent application filing date, a patent classification, a patent issuance date, a trademark application serial number, a trademark registration number, or a trademark classification.

16. The system of claim 9, the set of tables being stored in a resource database.

17. A computer program product for retrieving legal information in a networked computing environment, the computer program product comprising a computer readable storage media, and program instructions stored on the computer readable storage media, to:
receive search input in a computer memory medium;
query an intellectual property database using the search input to generate a set of results;
extract intellectual property identifier information from the set of results;
match the extracted intellectual property identifier information against a set of data contained in a set of tables, the set of data comprising deterministic information corresponding to a set of intellectual property assets; and
output, based on the match, the deterministic information for the intellectual property assets that correspond to the intellectual property identifier information extracted from the set of results.

18. The computer program product of claim 17, the search input comprising at least one of the following: a set of keywords, or a set of patent numbers.

19. The computer program product of claim 17, the intellectual property identifier information comprising a set of patent numbers, and the intellectual property assets comprising a set of patents.

20. The computer program product of claim 17, the deterministic information comprising legal information obtained from at least one legal database, and the legal information corresponding to a set of legal actions involving the set of intellectual property assets.

21. The computer program product of claim 20, the legal information comprising at least one of the following: a set of case numbers associated with the set of legal actions, identities of parties to the set of legal actions, dates in which the set of legal actions were filed, courts in which the set of legal actions are pending, or statuses of the set of legal actions.

22. The computer program product of claim 17, further comprising program instructions stored on the computer readable storage media to:
retrieve a set of legal documents from at least one legal database, the set of legal documents having legal information pertaining to a set of legal actions;
parse the set of legal documents to identify legal documents having intellectual property asset information; and
generate the set of tables based on the set of legal documents, the set of tables associating the legal information with the intellectual property asset information.

23. The computer program product of claim 17, the intellectual property asset information comprising at least one of the following: a patent application serial number, a patent number, a patent publication number, a title, an applicant, an assignee, a patent application filing date, a patent classification, a patent issuance date, a trademark application serial number, a trademark registration number, or a trademark classification.

24. The computer program product of claim 9, the set of tables being stored in a resource database.

25. A method for deploying a system for retrieving legal information in a networked computing environment, comprising:
providing a computer infrastructure being operable to:
receive search input in a computer memory medium;
query an intellectual property database using the search input to generate a set of results;
extract intellectual property identifier information from the set of results;
match the extracted intellectual property identifier information against a set of data contained in a set of tables, the set of data comprising deterministic information corresponding to a set of intellectual property assets; and
output, based on the match, the deterministic information for the intellectual property assets that correspond to the intellectual property identifier information extracted from the set of results.
